(19) United States
(12) Patent Application Publication
(10) Pub. No.: US 2007/0101176 A1
(43) Pub. Date: May 3, 2007

(54) POWER SWITCH CIRCUIT AND POWER SUPPLY SYSTEM USING THE SAME

(75) Inventor: SHIN-HUEI YEH, TU CHENG (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., TU CHENG (TW)

(21) Appl. No.: 11/308,632

(22) Filed: Apr. 14, 2006

(30) Foreign Application Priority Data
Oct. 28, 2005 (TW) 94137872

(51) Int. Cl. G06F 1/00

(52) U.S. Cl. 713/323

(57) ABSTRACT

A power switch circuit (400) includes a voltage divider circuit (401), a first reference voltage circuit (402), a second reference voltage circuit (403), a first compare circuit (404), a second compare circuit (405), a synthesizing circuit (406), and a switch circuit (407). The voltage divider circuit generates a divided voltage. The first reference voltage circuit and the second reference voltage circuit respectively generate a first reference voltage and a second reference voltage. The first compare circuit compares the first reference voltage with the divided voltage and generates a first comparison result. The second comparing circuit compares the second reference voltage with the divided voltage and generates a second comparison result. The synthesizing circuit synthesizes the first comparison result and the second comparison result, and generates a synthesized signal. The switch circuit switches on/off according to the synthesized signal.

1. Field of the Invention

The invention relates to power supply systems, and particularly to a power supply system with a power switch circuit.

2. Description of Related Art

Nowadays, central office terminals (COTs), such as asymmetrical digital subscriber loops (ADSLs), used in network communications require continuous power supply systems to ensure reliable operation. Therefore, most of the COTs have a main power supply and a backup power supply. When the main power supply becomes abnormal, the backup power supply starts up to provide power to the COTs.

FIG. 4 is a block diagram of an application environment of a conventional power switch circuit 40. A direct current (DC) power source 30 is a main power supply, and an alternating current (AC) power source 10 and an adaptor 20 constitute a backup power supply. When the main power supply operates normally, the DC power source 30 outputs a DC signal Vout1 to a COT 50 via a diode D2. When the main power supply operates abnormally, the power switch circuit 40 switches from the main power supply to the backup power supply. Therefore, the adaptor 20 converts an AC signal received from the AC power source 10 to another DC signal Vout2 to be transmitted to the COT 50 via a diode D1. The diodes D1 and D2 protect current of the power switch circuit 40 and the COT 50 from flowing back to the adaptor 20 and the DC power source 30.

FIG. 5 is a block diagram of the conventional power switch circuit 40. The power switch circuit 40 includes a voltage divider circuit 41, a reference voltage circuit 42, a compare circuit 43, and a switch circuit 44. The voltage divider circuit 41 divides the DC signal Vout1 output from the DC power source 30, and generates a divided voltage to the compare circuit 43. The reference voltage circuit 42 generates a reference voltage to the compare circuit 43. The reference voltage is the minimum voltage of the COT 50 for normal operation. The compare circuit 43 compares the reference voltage with the divided voltage. If the divided voltage is greater than the reference voltage, the switch circuit 44 remains off. No signal is output to the adaptor 20. Therefore, the COT 50 is powered by the DC power source 30. If the divided voltage is less than the reference voltage, the switch circuit 44 is switched on. Therefore, the COT 50 is powered by the backup power supply.

The conventional power switch circuit 40 has only a preset reference voltage, for example, 35V. When the DC signal Vout1 is less than 35V, the power switch circuit 40 switches from the main power supply to the backup power supply. If the DC power source 30 outputs a fluctuating DC signal Vout1, for example, the DC signal Vout1 fluctuates between 34V and 36V, the power switch circuit 40 correspondingly switches between the main power supply and the backup power supply. As a result, the COT 50 has unstable power supply, thereby shortening the lifetime of the adaptor 20.

### SUMMARY OF INVENTION

An exemplary embodiment of the invention provides a power switch circuit for switching from one power source to another. The power switch circuit includes a voltage divider circuit, a first reference voltage circuit, a second reference voltage circuit, a first compare circuit, a second compare circuit, a synthesizing circuit, and a switch circuit. The voltage divider circuit generates a divided voltage according to a received signal. The first reference voltage circuit and the second reference voltage circuit respectively generate a first reference voltage and a second reference voltage. The first compare circuit, connected to the voltage divider circuit and the first reference voltage circuit, compares the first reference voltage with the divided voltage and generates a first comparison result. The second compare circuit, connected to the voltage divider circuit and the second reference circuit, compares the second reference voltage with the divided voltage and generates a second comparison result. The synthesizing circuit, connected to the first compare circuit and the second compare circuit, synthesizes the first comparison result and the second comparison result, and generates a synthesized signal. The switch circuit is connected to the synthesizing circuit, and switches on/off according to the synthesized signal.

Another exemplary embodiment of the invention provides a power supply system for supplying power to a central office terminal (COT). The power supply system includes a direct current (DC) power source, an alternating current (AC) power source, an adaptor, and a power switch circuit. The DC power source provides a power supply to the COT. The adaptor is connected between the AC power source and the COT, for converting a received AC signal to another DC signal to be transmitted to the COT. The power switch circuit is connected between the DC power source and the adaptor, for switching from a power source to another power source. The power switch circuit includes a voltage divider circuit, a first reference voltage circuit, a second reference voltage circuit, a first compare circuit, a second compare circuit, a synthesizing circuit, and a switch circuit. The voltage divider circuit generates a divided voltage according to a received signal. The first reference voltage circuit and the second reference voltage circuit respectively generate a first reference voltage and a second reference voltage. The first compare circuit, connected to the voltage divider circuit and the first reference voltage circuit, compares the first reference voltage with the divided voltage and generates a first comparison result. The second compare circuit, connected to the voltage divider circuit and the second reference circuit, compares the second reference voltage with the divided voltage and generates a second comparison result. The synthesizing circuit, connected to the first compare circuit and the second compare circuit, synthesizes the first compared result and the second compared result and generates a synthesized signal. The switch circuit is connected to the synthesizing circuit, and switches on/off according to the synthesized signal.

Other advantages and novel features will become more apparent from the following detailed description of preferred embodiments when taken in conjunction with the accompanying drawings, in which:

### BRIEF DESCRIPTION OF DRAWINGS

FIG. 1 is a block diagram of an application environment of a power supply system of an exemplary embodiment of the present invention, the power supply including a power switch circuit;

FIG. 2 is a block diagram of the power switch circuit shown in FIG. 1;

FIG. 3 is a circuit diagram illustrating details of the power switch circuit shown in FIG. 1;

FIG. 4 is a block diagram of an application environment of a conventional power switch circuit; and

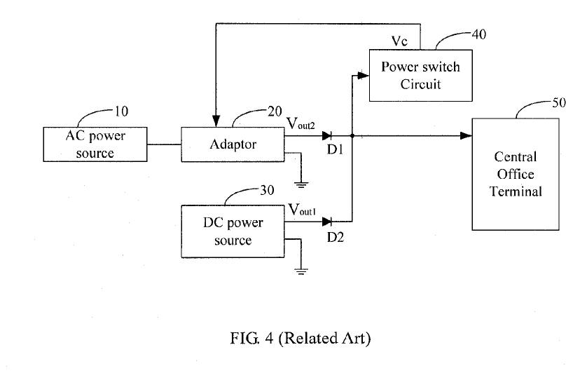

FIG. 5 is a block diagram of the conventional power switch circuit shown in FIG. 4.

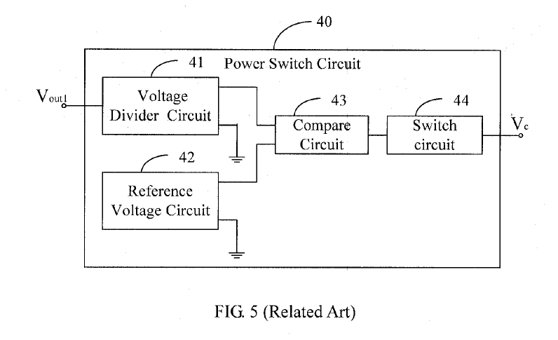

### DETAILED DESCRIPTION

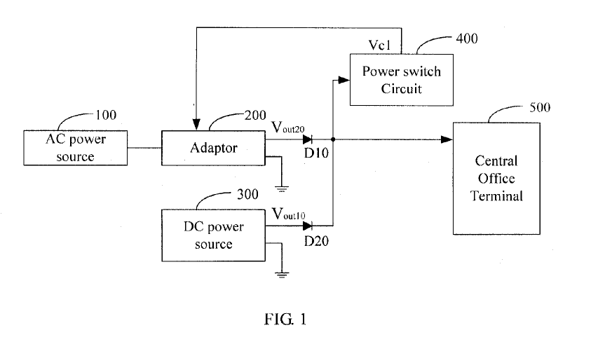

FIG. 1 is a block diagram of an application environment of a power supply system of an exemplary embodiment of the present invention. The power supply system includes an alternating current (AC) power source 100, an adaptor 200, a direct current (DC) power source 300, a power switch circuit 400, and a central office terminal (COT) 500.

In the exemplary embodiment, a main power supply is the DC power source 300, and a backup power supply includes the AC power source 100 and the adaptor 200. When the main power supply operates normally, the DC power source 300 outputs a DC signal Vout10 to the COT 500 via a diode D20. When the main power supply operates abnormally, the power switch circuit 400 switches from the main power supply to the backup power supply. Then, the adaptor 200 converts an AC signal received from the AC power source 100 to another DC signal Vout20 transmitted to the COT 500 via a diode D10.

In the exemplary embodiment, a normal working voltage of the COT 500, for example, is 48V, and the minimum working voltage of the COT 500, for example, is 35V. That is, when a DC signal output from the DC power source 300 is less than 35V, the power switch circuit 400 switches from a main power supply to a backup power supply.

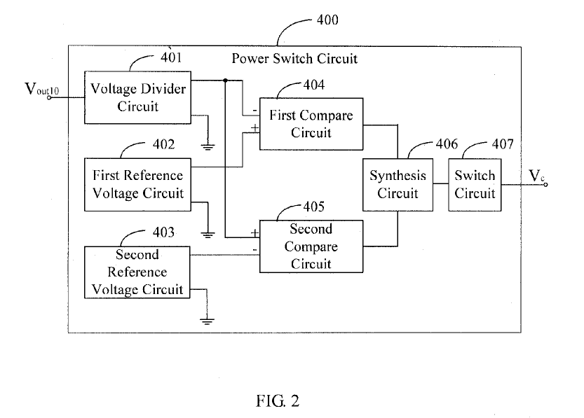

FIG. 2 is a block diagram of the power switch circuit 400 of an exemplary embodiment of the invention. The power switch circuit 400 includes a voltage divider circuit 401, a first reference voltage circuit 402, a second reference voltage circuit 403, a first compare circuit 404, a second compare circuit 405, a synthesizing circuit 406, and a switch circuit 407.

The voltage divider circuit 401 generates a divided voltage according to a received DC power signal Vout10. The first reference voltage circuit 402 and the second reference voltage circuit 403 generate a first reference voltage and a second reference voltage, respectively. The first compare circuit 404 compares the divided voltage with the first reference voltage, and outputs a first comparison result to the synthesizing circuit 406. The second compare circuit 405 compares the divided voltage with the second reference voltage, and outputs a second comparison result to the synthesizing circuit 406.

The synthesizing circuit 406 synthesizes the first compared result and the second compared result and generates a synthesized signal. The switch circuit 407 is switched on/off according to the synthesized signal. Therefore, the power switch circuit 400 can switch from the main power supply to the backup power supply. In the exemplary embodiment, the first reference voltage is 6V, and the second reference voltage is 5V.

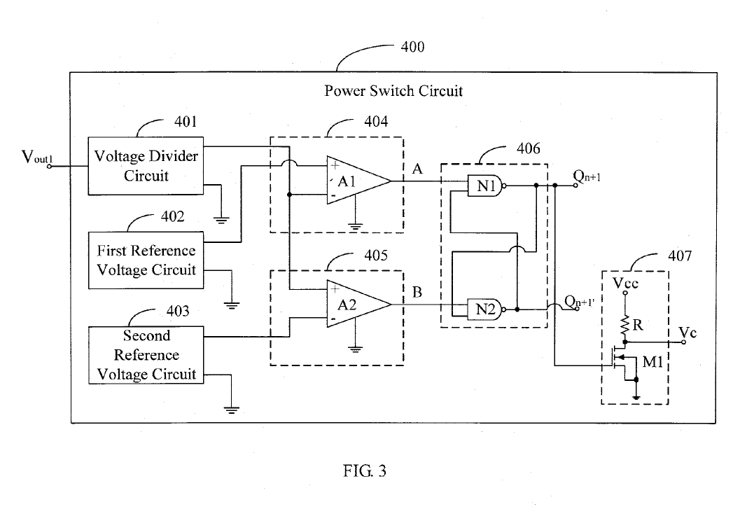

FIG. 3 is a circuit diagram illustrating details of the power switch circuit 400 as shown in FIG. 1. The first compare circuit 404 includes a first comparator A1 having a first input end, a second input end and an output end A. In the exemplary embodiment, the first input end of the first comparator A1 is positive, and is electrically connected to the first reference voltage circuit 402. The second input end of the first comparator A1 is negative, and is electrically connected to the voltage divider circuit 401.

The second compare circuit 405 includes a second comparator A2 having a first input end, a second input end, and an output end B. In the exemplary embodiment, the first input end of the second comparator A2 is positive, and is electrically connected to the voltage divider circuit 401. The second input end of the second comparator A2 is negative, and is electrically connected to the second reference voltage circuit 403.

The synthesizing circuit 406 includes a first NAND gate N1 and a second NAND gate N2, which respectively include a first input end, a second input end, and an output end. The first input end of the first NAND gate N1 is connected to the output end A of the first comparator A1, for receiving the first comparison result of the first compare circuit 404. The second input end of the first NAND gate N1 is connected to the output end Qn+1′ of the second NAND gate N2. The first input end of the second NAND gate N2 is connected to the output end B of the second comparator A2, for receiving the second comparison result of the second compare circuit 405. The second input end of the second NAND gate N2 is connected to the output end Qn+1 of the first NAND gate N1.

The switch circuit 407 includes a resistor R and a switch component M1. The switch component M1 has an input end, a first output end, and a second output end. In the exemplary embodiment, the switch component M1 is a metallic oxide semiconductor field effect transistor (MOSFET). The input end of the MOSFET M1 is a gate. The first output end of the MOSFET M1 is a drain. The second output end of the MOSFET M1 is a source. The gate of the MOSFET M1 is connected to the output end Qn+1 of the first NAND gate N1. The drain of the MOSFET M1 is connected to a power source Vcc via the resistor R, and the source of the MOSFET M1 is grounded. In addition, the drain of the MOSFET M1 outputs a signal Vc to the adaptor 200.

In the exemplary embodiment, the divided voltage is one seventh of DC power signal Vout10. The first NAND gate N1 and the second NAND gate N2 of the synthesizing circuit 406 operates based on a following truth table:

When the DC power signal output from the DC power source 300 is 48V, the divided voltage of the voltage divider circuit 401 is greater than the first reference voltage 6V and the second reference voltage 5V. Therefore, the output end A of the first comparator A1 outputs a logic low level 0, and the output end B of the second comparator A2 outputs a logic high level 1. According to the above truth table, the output end Qn+1 of the first NAND gate N1 outputs a logic high level 1, and the output end Qn+1′ of the second NAND gate N2 outputs a logic low level 0. As a result, the MOSFET M1 switches on, and a voltage signal output from the drain of the MOSFET M1 is 0 such that no signal is transmitted to the adaptor 200. Therefore, the COT 500 is powered by the main power supply, not by the backup power supply.

When the DC power signal output from the DC power source 300 drops from 48V to a value below 42V, for example, when the DC voltage output is 38V, the divided voltage of the voltage divider circuit 401 is less than the first reference voltage 6V, but greater than the second reference voltage 5V. Therefore, the output end A of the first comparator A1 outputs a logic high level 1, and the output end B of the second comparator A2 also outputs a logic high level 1. According to the above truth table, a logic level output from the output end Qn+1 of the first NAND gate N1 is a logic high level 1. A logic level output from the output end Qn+1′ of the second NAND gate N2 is a low voltage level 1. As a result, the MOSFET M1 switches on, and a voltage output from the drain of the MOSFET M1 is 0. Therefore, the COT 500 is powered by the main power supply, not by the backup power supply.

When the DC power signal output from the DC power source 300 drops from 42V to a value below 35V, for example, when the DC voltage output is 32V, which is the minimum working voltage of the COT 500. The divided voltage of the voltage divider circuit 401 is less than the first reference voltage 6V and the second reference voltage 5V. Therefore, the output end A of the first comparator A1 outputs a logic high level 1, and the output end B of the second comparator A2 outputs a logic low level 0. According to the above truth table, the output end Qn+1 of the first NAND gate N1 outputs a logic low level 0, and the output end Qn+1′ of the second NAND gate N2 outputs a logic high level 1. As a result, the MOSFET M1 switches off, and a voltage output from the drain of the MOSFET M1 is Vcc. Therefore, the COT 500 is powered by the backup power supply.

When the DC power signal outputted from the DC power source 300 rises from the 32V to 38V, the divided voltage of the voltage divider circuit 401 is less than the first reference voltage 6V, but greater than the second reference voltage 5V. Therefore, the output end A of the first comparator A1 outputs a logic high level 1, and the output end B of the second comparator A2 also outputs a logic high level 1. According to the above truth table, a logic level output from the output end Qn+1 of the first NAND gate N1 is a logic low level 0. A logic level output from the output end Qn+1′ of the second NAND gate N2 is a logic high level 1. As a result, the MOSFET M1 switches off, and a voltage output from the drain of the MOSFET M1 is Vcc. Therefore, the COT 500 is powered by the backup power supply.

When the DC voltage output from the DC power source 300 is rises from 38V to a value above 42V, for example, 48V, the divided voltage of the voltage divider circuit 401 is greater than the first reference voltage 6V and the second reference voltage 5V. Therefore, the output end A of the first comparator A1 outputs a logic low voltage level 0, and the output end B of the second comparator A2 outputs a logic high voltage level 1. According to the above truth table, the output end Qn+1 of the first NAND gate N1 outputs a logic high level 1, and the output end Qn+1′ of the second NAND gate N2 outputs a logic low level 1. As a result, the MOSFET M1 switches on, and a voltage output from the drain of the MOSFET M1 is 0. Therefore, the COT 500 is powered by the main power supply, not by the backup power supply.

In the exemplary embodiment, the DC voltage output from the DC power source 300 is divided into three ranges by the power switch circuit 400. The first voltage range is when the DC voltage is greater than 42V. The second voltage range is when the DC voltage is between 35V and 42V. The third voltage range is when the DC voltage is less than 35V. The second voltage range is a redundancy range of the power switch circuit 400. That is, when the DC voltage output from the DC power source 300 drops from the second voltage range to the third voltage range, the COT 500 is powered by the backup power supply. When the DC voltage output from the DC power source 300 rises from the third voltage range to the second voltage range, the COT 500 is also powered by the backup power supply, not by the main power supply.

In the present invention, the power switch circuit 400 not only ensures stability of a circuit, but also ensures operational reliability of the COT 500.

While embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A power switch circuit for switching from a power supply to another power supply, comprising:
a voltage divider circuit for generating a divided voltage according to a received signal;
a first reference voltage circuit for generating a first reference voltage;
a second reference voltage circuit for generating a second reference voltage;
a first compare circuit, connected to the voltage divider circuit and the first reference voltage circuit respectively, for comparing the divided voltage with the first reference voltage and generating a first comparison result;
a second compare circuit, connected to the voltage divider circuit and the second reference voltage circuit respectively, for comparing the divided voltage with the second voltage and generating a second comparison result;
a synthesizing circuit, connected to the first compare circuit and the second compare circuit respectively, for synthesizing the first comparison result and the second comparison result and generating a synthesized signal; and
a switch circuit, connected to the synthesizing circuit, for switching on/off according to the synthesized signal.

2. The power switch circuit as claimed in claim 1, wherein the first compare circuit comprises a first comparator having a first input end, a second input end, and an output end; wherein the first input end of the first comparator is connected to the first reference voltage circuit, and the second input end of the first comparator is connected to the voltage divider circuit.

3. The power switch circuit as claimed in claim 2, wherein the second compare circuit comprises a second comparator having a first input end, a second input end, and an output end; wherein the first input end of the second comparator is connected to the voltage divider circuit, and the second input end of the second comparator is connected to the second reference voltage circuit.

4. The power switch circuit as claimed in claim 3, wherein the synthesizing circuit comprises:
a first NAND gate having a first input end, a second input end, and an output end; and
a second NAND gate having a first input end, a second input end, and an output end;
wherein the first input end of the first NAND gate is connected to the output end of the first comparator, the first input end of the second NAND gate is connected to the output end of the second comparator, the output end of the first NAND gate is connected to the second input end of the second NAND gate, and the output end of the second NAND gate is connected to the second input end of the first NAND gate.

5. The power switch circuit as claimed in claim 4, wherein the switch circuit comprises:
a resistor; and
a switch component having an input end, a first output end, and a second output end;
wherein the input end of the switch component is connected to the output end of the first NAND gate, the first output end of the switch component is connected to a power source via the resistor, and the second output end of the switch component is grounded.

6. The power switch circuit as claimed in claim 5, wherein the switch component comprises a metallic oxide semiconductor field effect transistor (MOSFET).

7. The power supply system as claimed in claim 6, wherein the input end of the switch component is a gate, the first output end is a drain, and the second output end is a source.

8. A power supply system for supplying power to a central office terminal (COT), comprising:
a direct current (DC) power source for providing a power supply to the COT;
an alternating current (AC) power source;
an adaptor, connected to the AC power source, for converting an AC signal received from the AC power source to a DC signal adapted to the COT; wherein both the AC power source and the adaptor provide a second power supply;
a power switch circuit, connected between the DC power source and the adaptor, for switching from the power supply to the another power supply, comprising:
a voltage divider circuit for generating a divided voltage according to a received signal;
a first reference voltage circuit for generating a first reference voltage;
a second reference voltage circuit for generating a second reference voltage;
a first compare circuit, connected to the voltage divider circuit and the first reference voltage circuit respectively, for comparing the divided voltage with the first reference voltage and generating a first comparison result;
a second compare circuit, connected to the voltage divider circuit and the second reference voltage circuit respectively, for comparing the divided voltage with the second voltage and generating a second comparison result;
a synthesizing circuit, connected to the first compare circuit and the second compare circuit respectively, for synthesizing the first comparison result and the second comparison result and generating a synthesized signal; and
a switch circuit, connected to the synthesizing circuit, for switching on/off according to the synthesized signal.

9. The power supply system as claimed in claim 8, wherein the first compare circuit comprises a first comparator having a first input end, a second input end, and an output end; wherein the first input end of the first comparator is connected to the first reference voltage circuit, and the second input end of the first comparator is connected to the voltage divider circuit.

10. The power supply system as claimed in claim 9, wherein the second compare circuit comprises a second comparator having a first input end, a second input end, and an output end; wherein the first input end of the second comparator is connected to the voltage divider circuit, and the second input end of the second comparator is connected to the second reference voltage circuit.

11. The power supply system as claimed in claim 10, wherein the synthesizing circuit comprises:
a first NAND gate having a first input end, a second input end, and an output end; and
a second NAND gate having a first input end, a second input end, and an output end;
wherein the first input end of the first NAND gate is connected to the output end of the first comparator, the first input end of the second NAND gate is connected to the output end of the second comparator, the output end of the first NAND gate is connected to the second input end of the second NAND gate, and the output end of the second NAND gate is connected to the second input end of the first NAND gate.

12. The power supply system as claimed in claim 11, wherein the switch circuit comprises:
a resistor; and
a switch component having an input end, a first output end, and a second output end;
wherein the input end of the switch component is connected to the output end of the first NAND gate, the first output end of the switch component is connected to a power source via the resistor, and the second output end of the switch component is grounded.

13. The power supply system as claimed in claim 12, wherein the first output end of the switch component is electrically connected to the adaptor.

14. The power supply system as claimed in claim 12, wherein the switch component comprises a metallic oxide semiconductor field effect transistor (MOSFET).

15. The power supply system as claimed in claim 14, wherein the input end of the switch component is a gate, the first output end is a drain, and the second output end is a source.
